(19) United States
(12) Patent Application Publication
(10) Pub. No.: US 2024/0152106 A1
(43) Pub. Date: May 9, 2024

(54) ARTIFICIAL INTELLIGENCE BASED HARMFUL ENVIRONMENT CONTROL SYSTEM CONNECTED TO INTERNET OF THINGS AND ITS HARMFUL ENVIRONMENT CONTROL METHOD

(71) Applicant: EMB CO., LTD., Seoul (KR)

(72) Inventor: Kyung Hak PARK, Anyang-si (KR)

(73) Assignee: EMB CO., LTD., Seoul (KR)

(21) Appl. No.: 17/982,583

(22) Filed: Nov. 8, 2022

(51) Int. Cl. G05B 19/042

(52) U.S. Cl. CPC G05B 19/0428; G05B 2219/24008; G05B 2219/2614

(57) ABSTRACT

An artificial intelligence based harmful environment control system includes: a plurality of IoT sensors measuring a harmful element and an environmental element of a closed space, and whether there is a person in the closed space; a controller unit controlling to display a harmful element measurement value and an environmental element measurement value provided from the plurality of IoT sensors, comparing the harmful element measurement value with a reference range measurement value, deciding a control method corresponding to the determined harmful environment situation, selecting and controlling to output a guidance message corresponding to the harmful environment situation, and transmitting harmful element control information; a display panel displaying the harmful element measurement value and the environmental element measurement value, and displaying the guidance screen; a speaker voice-outputting the guidance message according to the control of the controller unit; and a ventilation operating device operated to resolve the harmful element.

### TECHNICAL FIELD

The present invention relates to an artificial intelligence based harmful environment control system connected to Internet of things and its harmful environment control method, and particularly, to an artificial intelligence based harmful environment control system connected to Internet of things and its harmful environment control method, which determine a control method by artificial intelligence according to a harmful element value measured by sensing at least one harmful element of carbon monoxide (CO), carbon dioxide (CO2), fine dust (PM10), ultrafine dust (PM2.5), radon, and volatile organic compound (VOC), and then, perform an operation control for solving the harmful element according to the determined control method to prevent casualties, and provide various home networking services including a remote control.

### BACKGROUND ART

As is well known, the Internet of Things (IoT) means a technology that connects the Internet by built-in sensors and communication functions in various things, is known as an artificial intelligence technology in which things connected by the Internet transmit and receive data and autonomously analyze the data and provide the learned information to a user or the user can remotely control the process.

Here, the things may include various embedded systems including home appliances, mobile equipment, wearable computers, etc., for example.

The things connected the Internet of things (IoT) should be connected by the Internet with unique IPs capable of distinguishing the things themselves, and may have various sensors embedded therein in order to acquire data from an external environment.

This as a concept developed from conventional Ubiquitous Sensor Network (USN) and Machine to Machine (M2M) is extended and recognized even to machine-to-machine communication and Internet of Everything (IoE).

Further, an intelligence Internet technology (IT) a service may be provided, which creates a new value in a human life by collecting and analyzing data generated from connected things in the IoT environment, and the intelligence IT service is applied in fields such as smart home, smart building, smart city, smart car or connected car, smart grid, healthcare, smart home appliances, and advanced medical services through convergence and combination of the conventional IT technology and various industries.

Meanwhile, accidents frequently occur such as occurrence of various diseases due to exposure to harmful gas in closed spaces (e.g., home, office, etc.) or even the death is caused in severe cases, and in the case of exposure to carbon monoxide (CO), carbon dioxide (CO2), fine dust (PM10), ultrafine dust (PM2.5), radon, and volatile organic compound (VOC) or inhalation of carbon monoxide (CO), carbon dioxide (CO2), fine dust (PM10), ultrafine dust (PM2.5), radon, and volatile organic compound (VOC), diseases such as lung diseases including lung cancer, cardiovascular disease, leukemia, etc., occur or casualties occur.

In order to solve such a problem, development of a system for resolving a harmful environment with artificial intelligence (AI) by using various sensors of the IoT environment in the closed spaces is required.

### PRIOR ART DOCUMENT

### Patent Document

1. (Patent Document 1) Korean Patent Registration No. 10-2106195 (registered Apr. 23, 2020)

### DISCLOSURE

### Technical Problem

The present invention has been made in an effort to provide an artificial intelligence based harmful environment control system connected to Internet of things and its harmful environment control method, which determine a harmful environment situation by artificial intelligence according to a harmful element value measured by sensing at least one harmful element of carbon monoxide (CO), carbon dioxide (CO2), fine dust (PM10), ultrafine dust (PM2.5), radon, and volatile organic compound (VOC), decide a control method corresponding to the determined harmful environment situation, and then perform an operation control for solving the harmful element according to the decided control method to prevent casualties, and provide various home networking services including a remote control.

Further, the present invention has been made in an effort to provide an artificial intelligence based harmful environment control system connected to Internet of things and its harmful environment control method, which decide a control method by referring to data accumulated for each time zone and each place where the harmful element is measured by the artificial intelligence, and decide and control the control method by supervised learning through a comparison with a reference range measurement value by using a harmful element measurement value, an environmental element measurement value, and whether there is a person provided through a plurality of IoTs, and then analyze and predict a dangerous situation through unsupervised learning using accumulated data and provide the analyzed and predicted dangerous situation to a user to actively resolve a harmful element which causes the dangerous situation, and prevent the resulting casualties.

Objects of embodiments of the present invention are not limited to the aforementioned objects and other unmentioned objects will be clearly understood by those skilled in the technical field to which the present invention belongs from the following description.

### Technical Solution

According to an aspect of the present invention, an artificial intelligence based harmful environment control system connected to Internet of things may be provided, which includes: a plurality of IoT sensors measuring a harmful element and an environmental element of a closed space, and whether there is a person in the closed space; a controller unit controlling to display a harmful element measurement value and an environmental element measurement value provided from the plurality of IoT sensors, comparing the harmful element measurement value with a reference range measurement value to determine a harmful environment situation by artificial intelligence according to the reference range measurement value and whether there is the person, deciding a control method corresponding to the determined harmful environment situation, and then selecting and providing an operation control signal for resolving a harmful element according to the decided control method, selecting and controlling to output a guidance message corresponding to the harmful environment situation, and transmitting harmful element control information including the harmful element measurement value, the environmental element measurement value, the harmful environment situation, and the control method; a display panel displaying the harmful element measurement value and the environmental element measurement value according to the control of the controller unit, and displaying the guidance screen; a speaker voice-outputting the guidance message according to the control of the controller unit; and a ventilation operating device operated to resolve the harmful element by receiving the operation control signal.

Further, according to an aspect of the present invention, the artificial intelligence based harmful environment control system connected to Internet of things may be provided, which includes: a wired/wireless communication network connected to the controller unit and transmitting the harmful environment control information; a harmful environment management server receiving the harmful environment control information through the wired/wireless communication network, and storing and managing the harmful environment control information; a plurality of communication terminals receiving the harmful environment control information through a harmful environment control application provided from the harmful environment management server; and a worker terminal connected to the controller unit through the wired/wireless communication network by a low-power communication method.

Further, according to an aspect of the present invention, the artificial intelligence based harmful environment control system connected to Internet of things may be provided, in which the plurality of communication terminals includes a manager terminal and a user terminal registered in the harmful environment control server, and the manager terminal receives a notification message corresponding to the harmful environment situation from the controller unit, and provides the received notification message.

Further, according to an aspect of the present invention, the artificial intelligence based harmful environment control system connected to Internet of things may be provided, in which the plurality of Internet of things sensors includes a harmful element measurement sensor 111 may measure a harmful element including at least one of carbon monoxide (CO), carbon dioxide (CO2), fine dust (PM10), ultrafine dust (PM2.5), radon, and volatile organic compound (VOC), and an environmental element measurement sensor measuring an environmental element including at least one of a temperature and a humidity, and an infrared sensor measuring whether there is the person.

Further, according to an aspect of the present invention, the artificial intelligence based harmful environment control system connected to Internet of things may be provided, in which the ventilation operating device opens/closes a window or a ventilation window according to the operation control signal.

Further, according to an aspect of the present invention, the artificial intelligence based harmful environment control system connected to Internet of things may be provided, in which the controller unit decides the control method by referring to data accumulated for each time zone and each place in which the harmful element is measured, and for each number of controls of the ventilation operating device by the artificial intelligence, and determine the harmful environment situation for each time zone and each place in which the harmful element is measured through supervised learning of machine learning including a decision tree technique, and analyze a harmful environment pattern according to the harmful element measurement value and the environmental element measurement value through unsupervised learning by referring to the accumulated data acquired by determining the harmful environment situation to determine the harmful environment situation.

According to another aspect of the present invention, an artificial intelligence based harmful environment control method connected to Internet of things may be provided, which includes: measuring a harmful element and an environmental element of a closed space, and whether there is a person in the closed space by using a plurality of IoT sensors; comparing, by a controller unit, the harmful element measurement value with the reference rang measurement value to determine the harmful environment situation by the artificial intelligence according to the reference range measurement value and whether there is the person, and then deciding the control method corresponding to the determined harmful environment situation; selecting and providing, by the controller unit, an operation control signal for resolving the harmful element according to the decided control method; outputting a guidance screen and a guidance message corresponding to the harmful environment situation according to the control of the controller unit; and operating, by a ventilation operating device, to resolve the harmful element according to the operation control signal.

Further, according to another aspect of the present invention, the artificial intelligence based harmful environment control method connected to Internet of things may be provided, which further includes: displaying the harmful element measurement value and the environmental element measurement value through the display panel when the harmful element measurement value and the environmental element measurement value are provided to the controller unit.

Further, according to another aspect of the present invention, the artificial intelligence based harmful environment control method connected to Internet of things may be provided, which further includes: transmitting harmful environment control information including the harmful element measurement value, the environmental element measurement value, the harmful environment situation, and the control method; and receiving, and storing and managing, by a harmful environment management server, the harmful environment control information.

Further, according to another aspect of the present invention, the artificial intelligence based harmful environment control method connected to Internet of things may be provided, which further includes: receiving and providing, by a plurality of communication terminals, the harmful environment control information transmitted by the harmful environment control server through a harmful environment control application; and receiving, by a manager terminal included in the plurality of communication terminals, a notification message corresponding to the harmful environment situation from the controller unit, and providing the received notification message.

Further, according to another aspect of the present invention, the artificial intelligence based harmful environment control method connected to Internet of things may be provided, in which in the measuring and providing of whether there is the person, a harmful element measurement sensor measures a harmful element including at least one of carbon monoxide (CO), carbon dioxide (CO2), fine dust (PM10), ultrafine dust (PM2.5), radon, and volatile organic compound (VOC), an environmental element measurement sensor measures an environmental element including at least one of a temperature and a humidity, and an infrared sensor measures whether there is the person.

Further, according to another aspect of the present invention, the artificial intelligence based harmful environment control method connected to Internet of things may be provided, in which in the deciding of the control method, the control method is decided by referring to data accumulated for each time zone and each place in which the harmful element is measured, and for each number of controls of the ventilation operating device by the artificial intelligence, and the harmful environment situation is determined for each time zone and each place in which the harmful element is measured through supervised learning of machine learning including a decision tree technique, and a harmful environment pattern according to the harmful element measurement value and the environmental element measurement value is analyzed through unsupervised learning by referring to the accumulated data acquired by determining the harmful environment situation to determine the harmful environment situation.

Further, according to another aspect of the present invention, the artificial intelligence based harmful environment control method connected to Internet of things may be provided, in which in the operating to resolve the harmful element, a window or a ventilation window is opened/closed according to the operation control signal.

### Advantageous Effects

According to the present invention, a harmful environment situation is determined by artificial intelligence according to a harmful element value measured by sensing at least one harmful element of carbon monoxide (CO), carbon dioxide (CO2), fine dust (PM10), ultrafine dust (PM2.5), radon, and volatile organic compound (VOC), a control method corresponding to the determined harmful environment situation is decided, and then an operation control for solving the harmful element is performed according to the decided control method to prevent casualties, and provide various home networking services including a remote control.

Further, according to the present invention, a control method is decided by referring to data accumulated for each time zone and each place where the harmful element is measured by the artificial intelligence, and the control method is decided and controlled by supervised learning through a comparison with a reference range measurement value by using a harmful element measurement value, an environmental element measurement value, and whether there is a person provided through a plurality of IoTs, and then a dangerous situation is analyzed and predicted through unsupervised learning using accumulated data and the analyzed and predicted dangerous situation is provided to a user to actively resolve a harmful element which causes the dangerous situation, and prevent the resulting casualties.

### DESCRIPTION OF DRAWINGS

FIG. 1 is a block diagram illustrating an artificial intelligence based harmful environment control system connected to the Internet of things according to an embodiment of the present invention;

FIG. 2 is a diagram conceptually illustrating the artificial intelligence based harmful environment control system connected to the Internet of things according to an embodiment of the present invention;

FIGS. 3 to 7 are diagrams for describing a reference range measurement value for determining a harmful environment situation in the artificial intelligence based harmful environment control system connected to the Internet of things according to an embodiment of the present invention;

FIG. 8 is a diagram for describing control method deciding of an artificial intelligence method in a controller unit according to an embodiment of the present disclosure;

FIG. 9 is a diagram illustrating a control device of the artificial intelligence based harmful environment control system connected to the Internet of things according to an embodiment of the present invention; and

FIG. 10 is a flowchart illustrating a process of controlling an artificial intelligence based harmful environment connected to the Internet of things according to another embodiment of the present invention.

### MODES FOR THE INVENTION

Advantages and features of embodiments of the present invention, and methods for accomplishing the same will be more clearly understood from embodiments described in detail below with reference to the accompanying drawings. However, the present disclosure is not limited to the embodiments set forth below, and may be embodied in various different forms. The present embodiments are just for rendering the disclosure of the present disclosure complete and are set forth to provide a complete understanding of the scope of the invention to a person with ordinary skill in the technical field to which the present disclosure pertains, and the present disclosure will only be defined by the scope of the claims. Throughout the whole specification, the same reference numerals denote the same elements.

In describing the embodiment of the present invention, a detailed description of known function or constitutions will be omitted when it is judged that the detailed description may unnecessarily make the gist of the present invention unclear. In addition, terms to be described below as terms which are defined in consideration of functions in the embodiment of the present invention may vary depending on the intention of a user or an operator or usual practice. Accordingly, the terms need to be defined based on contents throughout this specification.

Hereinafter, embodiments of the present invention will be described in detail with reference to the accompanying drawings.

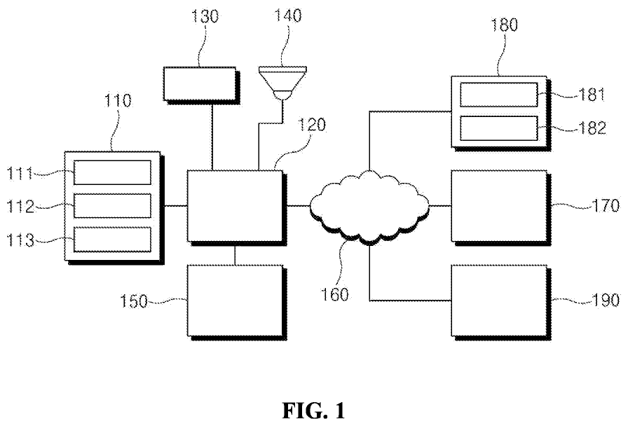

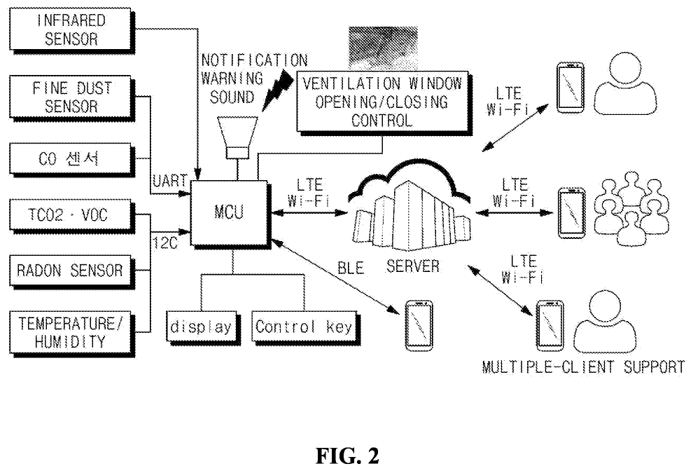

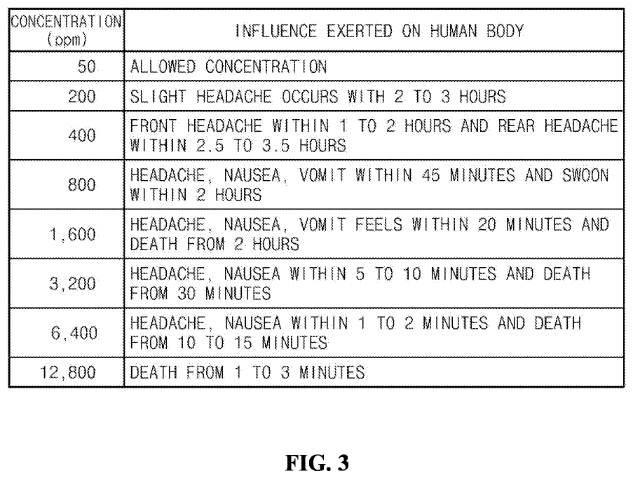

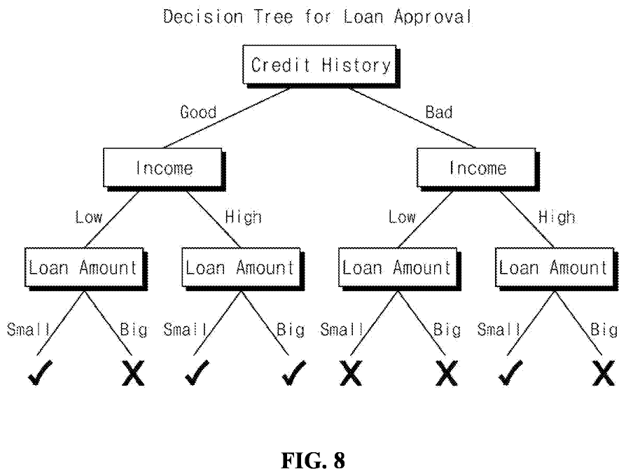

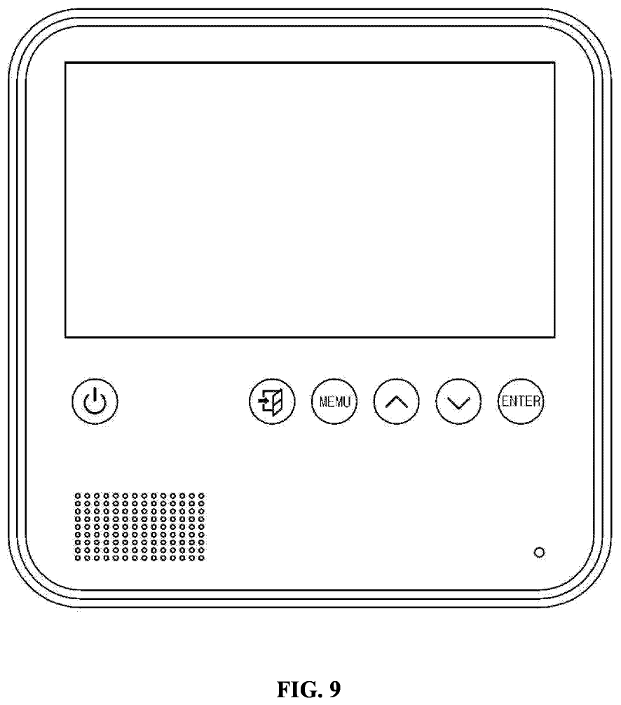

FIG. 1 is a block diagram illustrating an artificial intelligence based harmful environment control system connected to the Internet of things according to an embodiment of the present invention, FIG. 2 is a diagram conceptually illustrating the artificial intelligence based harmful environment control system connected to the Internet of things according to an embodiment of the present invention, FIGS. 3 to 7 are diagrams for describing a reference range measurement value for determining a harmful environment situation in the artificial intelligence based harmful environment control system connected to the Internet of things according to an embodiment of the present invention, FIG. 8 is a diagram for describing control method deciding of an artificial intelligence method in a controller unit according to an embodiment of the present disclosure, and FIG. 9 is a diagram illustrating a control device of the artificial intelligence based harmful environment control system connected to the Internet of things according to an embodiment of the present invention.

Referring to FIGS. 1 to 9, the artificial intelligence based harmful environment control system connected to the Internet of things according to an embodiment of the present invention may include a plurality of Internet of things sensors 110, a controller unit 120, a display panel 130, a speaker 140, a ventilation operating device 150, a wired/wireless communication network 160, a harmful environment management server 170, a plurality of communication terminals 180, a worker terminal 190, etc.

The plurality of IoT sensors 110 may measure a harmful element and an environmental element of a closed space, and whether there is a person in the closed space in real time or for a predetermined time period (e.g., 30 minutes, 1 hour, etc.).

For example, in the closed space (e.g., home, office, etc.), for example, the plurality of IoT sensors 110 may include, for example, a harmful element measurement sensor 111 measuring a harmful element including at least one of carbon monoxide (CO), carbon dioxide (CO2), fine dust (PM10), ultrafine dust (PM2.5), radon, and volatile organic compound (VOC) in the closed space (e.g., home, office, etc.), an environmental element measurement sensor 112 measuring an environmental element including at least one of a temperature and a humidity, and an infrared sensor 113 measuring whether there is the person.

Here, since the harmful element measurement sensor 111, the environment elemental element measurement sensor 112, and the infrared sensor 113 are variously disclosed conventionally, a detailed description of operating methods thereof, etc., will be omitted.

As the plurality of IoT sensors 110, respective sensors may be installed or a plurality of sensors having a plurality of functions may be installed, and sensors measuring the fine dust (PM10) and the ultrafine dust (PM2.5) may also be configured as one, and the sensors measuring the temperature and the humidity may also be configured as one.

The controller unit 120 may control to display the harmful element measurement value and the environmental element measurement value provided from the plurality of IoT sensors 110, compare the harmful element measurement value with a reference range measurement value to determine the harmful environment situation by the artificial intelligence according to the reference range measurement value and whether there is the person, decide the control method corresponding to the determined harmful environment situation, and then select and provide an operation control signal for resolving the harmful element according to the decided control method, select and control to output a guidance message corresponding to the harmful environment situation, and transmit harmful element control information including the harmful element measurement value, the environmental element measurement value, the harmful environment situation, and the control method.

Here, the controller unit 120 is connected to the plurality of IoT sensors 110, the ventilation operating device 150, etc., to provide signal by an Internet of things (IoT) method, and the display panel 130, the speaker 140, etc., may be provided as a form provided integrally with the controller unit 120.

Further, the controller unit 120 includes a wired/wireless communication module to mutually communicate with the harmful environment management server 170 through the wired/wireless communication network 160, and the wired/wireless communication module may include a wired communication module such as RS232, etc., for example and wireless communication modules such as RF, zigbee, bluetooth, wi-fi, wibro, near field communication (NFC), bluetooth low energy (BLE), etc., for example.

For example, the controller unit 120 may receive the harmful element measurement value (e.g., a carbon monoxide (CO) measurement value, a carbon dioxide (CO2) measurement value, a fine dust (PM10) measurement value, an ultrafine dust (PM2.5) measurement value, a radon measurement value, a volatile organic compound (VOC) measurement value, etc.), an environmental element measurement value (e.g., a temperature measurement value, a humidity measurement value, etc.), and a person presence measurement value from the plurality of IoT sensors 110.

In this case, the controller unit 120 may provide a display control signal to the display panel 130 so as to display the harmful element measurement value and the environmental element measurement value through the display panel 130.

The controller unit 120 receives the carbon monoxide (CO) measurement value from the harmful element measurement sensor 111 of the plurality of IoT sensors 110 and when the carbon monoxide (CO) measurement value is in a normal range of 50 ppm or less in the reference range measurement value, the controller unit 120 may wait for providing a subsequent measurement value while maintaining a current ventilation state. Here, the reference range measurement value may be set by referring to a table which influences the human body in response to the carbon monoxide (CO) measurement value (concentration) as illustrated in FIG. 3.

In addition, in the case of a range of 51 to 200 ppm, the harmful environment situation may be determined as a primary caution state, a control method of primarily partially opening a window or a ventilation window (e.g., 30% opening of door and window, opening of one ventilation window, etc.) may be decided according to the primary caution state, and then an operation control signal for controlling the ventilation operating device 150 may be provided according to the decided control method, a guidance screen for announcing the primary caution state may be controlled to be generated and displayed through the display panel 130, and a guidance message for announcing the primary caution state may be controlled to be voice-output through the speaker 140.

In addition, in the case of a range of 201 to 400 ppm, the harmful environment situation may be determined as a secondary caution state, a control method of secondarily partially opening the window or the ventilation window (e.g., 60% opening of door and window, opening of two ventilation windows, etc.) may be decided according to the secondary caution state, and then the operation control signal for controlling the ventilation operating device 150 may be provided according to the decided control method, a guidance screen for announcing the secondary caution state may be controlled to be generated and displayed through the display panel 130, and a guidance message for announcing the secondary caution state may be controlled to be voice-output through the speaker 140.

In addition, in the case of a range of 401 ppm or more, the harmful environment situation may be determined as a dangerous state, a control method of fully opening the window or the ventilation window (e.g., 100% opening of door and window, opening of all ventilation windows, etc.) may be decided according to the secondary caution state, and then the operation control signal for controlling the ventilation operating device 150 may be provided according to the decided control method, a guidance screen for announcing the dangerous state may be controlled to be generated and displayed through the display panel 130, and a guidance message for announcing the dangerous state may be controlled to be voice-output through the speaker 140.

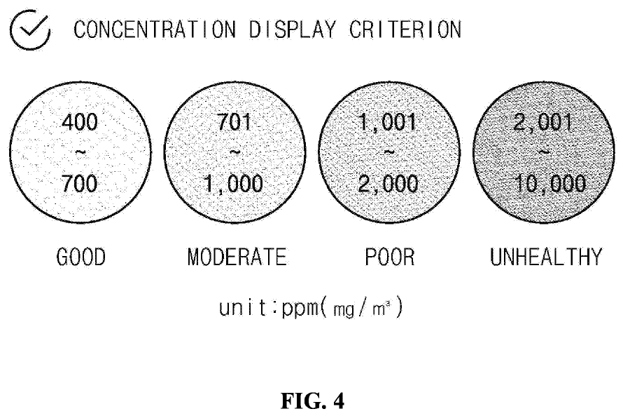

Meanwhile, the controller unit 120 receives the carbon dioxide (CO2) measurement value from the harmful element measurement sensor 111 of the plurality of IoT sensors 110 and when the carbon dioxide (CO2) measurement value is in a normal range of 1000 ppm or less in the reference range measurement value, the controller unit 120 may wait for providing a subsequent measurement value while maintaining the current ventilation state. Here, the reference range measurement value may be set by referring to a concentration display reference corresponding to the carbon dioxide (CO2) measurement value (concentration) illustrated in FIG. 4.

In addition, in the case of a range of 1001 to 2000 ppm, the harmful environment situation may be determined as a caution state, a control method of primarily partially opening a window or a ventilation window (e.g., 30% or 60% opening of door and window, opening of one or two ventilation windows, etc.) may be decided according to the caution state, and then an operation control signal for controlling the ventilation operating device 150 may be provided according to the decided control method, a guidance screen for announcing the caution state may be controlled to be generated and displayed through the display panel 130, and a guidance message for announcing the caution state may be controlled to be voice-output through the speaker 140.

In addition, in the case of a range of 2000 ppm or more, the harmful environment situation may be determined as the dangerous state, a control method of fully opening the window or the ventilation window (e.g., 100% opening of door and window, opening of all ventilation windows, etc.) may be decided according to the dangerous state, and then the operation control signal for controlling the ventilation operating device 150 may be provided according to the decided control method, a guidance screen for announcing the dangerous state may be controlled to be generated and displayed through the display panel 130, and a guidance message for announcing the dangerous state may be controlled to be voice-output through the speaker 140.

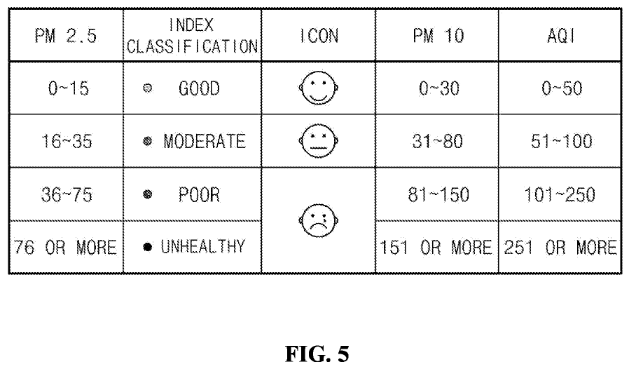

Meanwhile, the controller unit 120 receives the fine dust (PM10) measurement value and the ultrafine dust (PM2.5) from the harmful element measurement sensor 111 of the plurality of IoT sensors 110 and when the fine dust (PM10) measurement value is in a normal range of 100 μg/m 3 or less in the reference range measurement value and the ultrafine dust (PM2.5) measurement value is in a normal range of 50 lag/m 3 or less in the reference range measurement value, the controller unit 110 may wait for providing the subsequent measurement value while maintaining the current ventilation state. Here, the reference range measurement value may be set by referring to an index classification for the fine dust (PM10) measurement value and the ultrafine dust (PM2.5) measurement value illustrated in FIG. 5.

In addition, in a case where the fine dust (PM10) measurement value is a range of 101 to 150 μg/m³ or the ultrafine dust (PM2.5) measurement value is in a range of 51 to 75 μg/m³, the harmful environment situation may be determined as a caution state, a control method of primarily partially opening a window or a ventilation window (e.g., 30% or 60% opening of door and window, opening of one or two ventilation windows, etc.) may be decided according to the caution state, and then an operation control signal for controlling the ventilation operating device 150 may be provided according to the decided control method, a guidance screen for announcing the caution state may be controlled to be generated and displayed through the display panel 130, and a guidance message for announcing the caution state may be controlled to be voice-output through the speaker 140.

In addition, in a case where the fine dust (PM10) measurement value is a range of 151 μg/m³ or the ultrafine dust (PM2.5) measurement value is in a range of 76 μg/m³, the harmful environment situation may be determined as the dangerous state, a control method of fully opening the window or the ventilation window (e.g., 100% opening of door and window, opening of all ventilation windows, etc.) may be decided according to the dangerous state, and then the operation control signal for controlling the ventilation operating device 150 may be provided according to the decided control method, a guidance screen for announcing the dangerous state may be controlled to be generated and displayed through the display panel 130, and a guidance message for announcing the dangerous state may be controlled to be voice-output through the speaker 140.

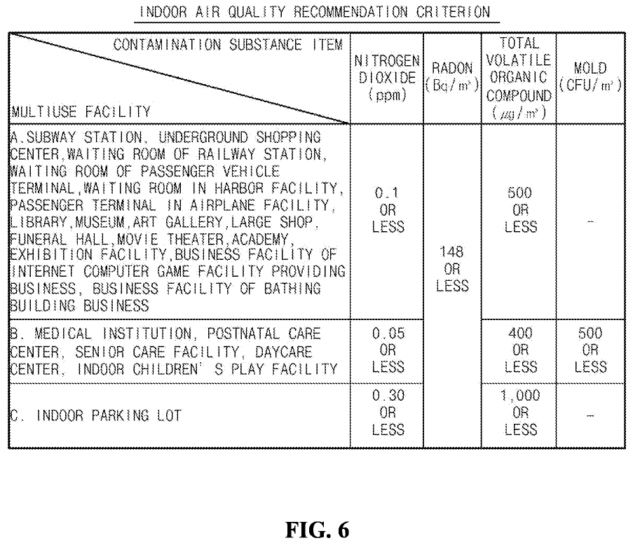

Meanwhile, the controller unit 120 receives the radon measurement value from the harmful element measurement sensor 111 of the plurality of IoT sensors 110 and when the radon measurement value is in a normal range of 148 Bq/m³ or less (or 4 pC/L or less), or less in the reference range measurement value, the controller unit 120 may wait for providing a subsequent measurement value while maintaining the current ventilation state. Here, the reference range measurement value may be set by referring to an indoor air quality recommendation criterion illustrated in FIG. 6.

In addition, in the case of a range of 149 to 300 Bq/m³, the harmful environment situation may be determined as a caution state, a control method of primarily partially opening a window or a ventilation window (e.g., 30% or 60% opening of door and window, opening of one or two ventilation windows, etc.) may be decided according to the caution state, and then an operation control signal for controlling the ventilation operating device 150 may be provided according to the decided control method, a guidance screen for announcing the caution state may be controlled to be generated and displayed through the display panel 130, and a guidance message for announcing the caution state may be controlled to be voice-output through the speaker 140.

In addition, in the case of a range of 301 Bq/m³ or more, the harmful environment situation may be determined as the dangerous state, a control method of fully opening the window or the ventilation window (e.g., 100% opening of door and window, opening of all ventilation windows, etc.) may be decided according to the dangerous state, and then the operation control signal for controlling the ventilation operating device 150 may be provided according to the decided control method, a guidance screen for announcing the dangerous state may be controlled to be generated and displayed through the display panel 130, and a guidance message for announcing the dangerous state may be controlled to be voice-output through the speaker 140.

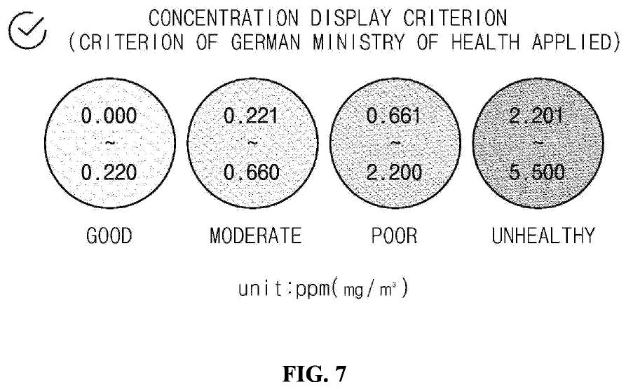

Meanwhile, the controller unit 120 receives the VOC measurement value from the harmful element measurement sensor 111 of the plurality of IoT sensors 110 and when the VOC measurement value is in a normal range of 660 ppm in the reference range measurement value, the controller unit 120 may wait for providing a subsequent measurement value while maintaining the current ventilation state. Here, the reference range measurement value may be set by referring to the concentration display reference corresponding to the VOC measurement value illustrated in FIG. 7.

In addition, in the case of a range of 661 to 2200 ppm, the harmful environment situation may be determined as a caution state, a control method of primarily partially opening a window or a ventilation window (e.g., 30% or 60% opening of door and window, opening of one or two ventilation windows, etc.) may be decided according to the caution state, and then an operation control signal for controlling the ventilation operating device 150 may be provided according to the decided control method, a guidance screen for announcing the caution state may be controlled to be generated and displayed through the display panel 130, and a guidance message for announcing the caution state may be controlled to be voice-output through the speaker 140.

In addition, in the case of a range of 2201 ppm or more, the harmful environment situation may be determined as the dangerous state, a control method of fully opening the window or the ventilation window (e.g., 100% opening of door and window, opening of all ventilation windows, etc.) may be decided according to the dangerous state, and then the operation control signal for controlling the ventilation operating device 150 may be provided according to the decided control method, a guidance screen for announcing the dangerous state may be controlled to be generated and displayed through the display panel 130, and a guidance message for announcing the dangerous state may be controlled to be voice-output through the speaker 140.

In the case where the harmful environment situation is determined as the caution state or the dangerous state, the controller unit 120 may transmit the harmful environment control information to the harmful environment management server 170 through the wired/wireless communication network 160 while storing and managing the harmful environment control information (e.g., the harmful element measurement value, the environmental element measurement value, the harmful environment situation, and the control method) corresponding to the caution state or the dangerous state.

Here, harmful environment control information may include all information such as a place where the measurement value is measured, a measurement time zone, the number of controls, etc., when the harmful environment situation is determined as the caution state or the dangerous state.

Further, it is described that the controller unit 120 controls to voice-output the guidance message for announcing the harmful environment situation such as the caution state, the dangerous state, etc., through the speaker 140, but in the case where each measurement value is the value in the normal rage or in the case where it is measured that there is no person inside the closed space (i.e., home, office, etc.) through the infrared sensor 113, the controller unit 120 may control not output a guidance message voice of the speaker 140.

Meanwhile, in determining the control method, the controller unit 120 may decide the control method by referring to data accumulated for each time zone and each place in which the harmful element is measured, and for each number of controls of the ventilation operating device 150 by the artificial intelligence, and determine the harmful environment situation for each time zone and each place in which the harmful element is measured through supervised learning of machine learning including a decision tree technique, and analyze a harmful environment pattern according to the harmful element measurement value and the environmental element measurement value through unsupervised learning by referring to the accumulated data acquired by determining the harmful environment situation to determine the harmful environment situation.

For example, harmful element measurement values collected by sensors installed in different places (e.g., different rooms, different offices, etc.) in the closed space to accumulate and store data (i.e., a measurement state, a state, etc.) for places (e.g., bedroom, library, kitchen, veranda, living room, etc.) where and time zones (e.g., morning, day, evening, late night, etc.) when the harmful elements are frequently generated or generated relatively high.

Further, the controller unit 120 may accumulate and store the number of controls of controlling the operation of the ventilation operating device 150 according to the decided control method, and moreover, accumulate and store the number of times of transmitting the harmful environment control information including the number of risk warning times to the manager, the user, the worker, etc.

The controller unit 120 may transmit a warning message for requesting a safety inspection a surrounding environment and a harmful substance generating object for a space (region) in which a harmful substance (i.e., harmful element) is repeatedly measured) to the harmful environment management server 170 through the wired/wireless communication network 160, and when the harmful substance (i.e., harmful element) is repeatedly measured in a specific time zone such as a sleep time, the controller unit 120 may transmit a warning message for requesting the safety inspection of a boiler, a heating device, etc., to the harmful environment management server 170 through the wired/wireless communication network 160.

The controller unit 120 may determine the harmful environment situation by the artificial intelligence and decide the control method corresponding thereto, and combine the harmful environment control information that analyzes a supervised learning result of the machine learning each time and provides the warning message with previous accumulated data and store and manage the combined information and data as new accumulated data, and decide the control method by referring to the data accumulated for each time zone and each place, and the number of controls of the ventilation operating device 150 through the unsupervised learning.

For example, the controller unit 120 may decide the control method by using the decision tree technique during the supervised learning of the machine learning, and this has a structure of drawing a model by utilizing a tool such as a decision tree technique as illustrated in FIG. 8, and a model that selects an appropriate node from a root, and then finally decide the node, and has an advantage of being easily understood and being capable of interpreting a result. Thereafter, the dangerous situation may be predicted and controlled by a method of group analysis through active execution by the unsupervised learning.

Meanwhile, the controller unit 120 may continuously determine the dangerous situation (harmful environment situation) by using the harmful element measurement value and the environmental element measurement value delivered from the plurality of IoT sensors 110 as described above, and in a case of carbon monoxide (CO) is in a range of 51 to 200 ppm, the dangerous situation may be determined as the primary caution state, in a case where carbon monoxide (CO) is in a range of 201 to 400 ppm, the dangerous situation may be determined as the secondary caution state, in a case where carbon monoxide (CO) is in a range of 401 ppm or more, the dangerous situation may be determined as the dangerous state, in a case where carbon monoxide (CO) is in a range of 1001 to 2000 ppm, the dangerous situation may be determined as the caution state, and in a case where carbon monoxide (CO) is in a range of 2000 ppm or more.

Further, with respect to the fine dust (PM10) and the ultrafine dust (PM2.5), in the case where the fine dust (PM10) measurement value is in the range of 101-150 μg/m³ or the ultrafine dust (PM2.5) measurement value is in the range of 51-75 μg/m³, the controller 120 may determine the dangerous situation as the caution state and in the case where the fine dust (PM10) measurement value is in the range of 151 μg/m 3 or more or the ultrafine dust (PM2.5) measurement value is in the range of 76 μg/m 3 or more, the controller 120 may determine the dangerous situation as the dangerous state.

In addition, the controller unit 120 may determine the dangerous situation as the caution state in the case where the radon is in the range of 149 to 300 Bq/m³ and determine the dangerous situation as the dangerous state in the case where the radon is in the range of 301 Bg/m 3 or more, and determine the dangerous situation as the caution state in the case of the VOC is in the range of 661 to 2200 ppm and determine the dangerous situation as the dangerous state when the VOC in the range of 2201 ppm or more.

In the case of determining the dangerous situation as the dangerous state as described above, the controller unit 120 may transmit a notification message indicating that a current closed space is in the dangerous situation to the manager terminal 181 included in the plurality of communication terminals 180 through the wired/wireless communication network 160, and moreover, control to display a guidance screen for notifying the dangerous situation to the display panel 130.

The display panel 130 which displays the harmful element measurement value and the environmental element measurement value according to the control of the controller unit 120 may display the harmful element measurement value and the environmental element measurement value by using, for example, LCD, OLED, etc.

Here, the harmful element measurement values such as the carbon dioxide (CO) measurement value, the carbon dioxide (CO2) measurement value, the fine dust (PM10) measurement value, the ultrafine dust (PM2.5) measurement value, the radon measurement value, the VOC measurement value, etc., and the environmental element measurement values such as the temperature measurement value, the humidity measurement value, etc., may be cyclically displayed one by one when inputting a separate control key.

The display panel 130 is provided in a touch screen method to be provided to input the control key by touching a panel surface, of course.

The harmful element measurement values and the environmental element measurement values may be displayed by the control of the controller unit 120 according to a measurement time or the harmful element measurement value and the environmental element measurement value measured recently may be displayed when inputting the separate control key.

The speaker 140 which voice-outputs the guidance message according to the control of the controller unit 120 may receive voice output data provided according to the control method from the controller unit 120 and voice-output the voice output data.

For example, in the case of the caution state, voice data (warning message) corresponding to the caution state may be received from the controller unit 120, and voice-output, and in the case of the dangerous state, a voice message (warning message corresponding to the dangerous state may be received from the controller unit 120 and voice-output.

Meanwhile, the controller unit 120, the display panel 130, and the speaker 140 may be provided as an integrated form of the control device illustrated in FIG. 9, and installed at a place (e.g., the living room, an entrance, etc.) where it is most convenient to use the controller unit 120, the display panel 130, and the speaker 140 in the closed space.

The ventilation operating device 150 which operates to resolve the harmful element by receiving the operation control signal from the controller unit 120 may include a driving motor connected to the window or the ventilation window to open/close the window or the ventilation window, and open/close the window or the ventilation window by operating the driving motor.

Here, the ventilation operating device 150 may receive the operation control signal corresponding to the control method from the controller unit 120, and ventilate internal air by operating and opening a predetermined number of such as some, one, multiple, or all windows or ventilation windows according to the operation control signal corresponding to the control method decided according to the harmful environment situation such as safety, caution, and danger.

The ventilation operating device 150 operates the windows or the ventilation windows connected to multiple DC+12V/+24V output ports, respectively to open/close windows or ventilation windows of a desired ratio or a desired number. For example, the window or the ventilation window may be operated by a method in which in the caution state, a part (e.g., 30%, 60%, etc., of one window) is opened or one ventilation window is opened, and in the dangerous state, the entirety (e.g., the entire window, etc.) is opened or all of multiple ventilation windows are opened.

Meanwhile, the ventilation operating device 150 may include an air-conditioner, an air cleaner, etc., and the ventilation operating device 150 operates the air-condition according to the control method decided by the artificial intelligence in response to the caution state, the dangerous state, etc., from the controller unit 120 to activate functions such as blowing, cleaning, etc., and operates the air cleaner to activate an air cleaning function.

The wired/wireless communication network 160 which is connected to the controller unit 120 to transmit the harmful environment control information may be in charge of mutual data communication between the controller unit 120, and the harmful environment management server 170 and multiple communication terminals 180, and may include wired communication such as RS232, etc., for example and wireless communication such as RF, zigbee, bluetooth, wi-fi, wibro, near field communication (NFC), bluetooth low energy (BLE), etc., for example.

The harmful environment management server 170 as a server that receives, and stores and manages the harmful environment control information transmitted from the controller unit 120 through the wired/wireless communication network 160 may store (or accumulate and store) and manage the harmful environment control information transmitted from the controller unit 120 through the wired/wireless communication network 160.

The harmful environment management server 170 may provide registered harmful environment information (or harmful environment control information) for the closed space to a registered manager and a registered user, and this may be provided to multiple communication terminals 180 through a separate harmful environment management application or received by a method by accessing and search a website of the harmful environment management server 170 by multiple communication terminals 180.

In addition, the harmful environment management server 170 may transmit the warning message to the manager terminal 181 and the user terminal 182 which are pre-registered when the harmful environment control information is transmitted from the controller unit 120 and transmission of the warning message is requested according to the situation such as the caution, the danger, etc.

In addition, the harmful environment management server 170 may analyze the accumulated and stored, and managed harmful environment information based on the harmful environment control information, and separately transmit the warning message to the manager terminal 181 and the user terminal 182 when it is determined that the harmful environment situation is the dangerous situation according to the measurement value or the number of warnings.

The harmful environment management server 170 may provide a remote control function, and when the manager terminal 181 and the user terminal 182 accesses the website or accesses the website through a harmful environment management application to transmit a control command of controlling the ventilation operating device 150 (i.e., opening/closing the window or the ventilation window), the harmful environment management server 170 may transmit the control command to the controller unit 120 through the wired/wireless communication network 160.

The multiple communication terminals 180 which receive the harmful environment control information through a harmful environment control application provided from the harmful environment management server 170 may include, for example, the manager terminal 181 and the user terminal 182 which are registered in the harmful environment management server 170.

The multiple communication terminals 180 may receive the warning message according to the situation such as the caution, the danger, etc., in response to the harmful environment control information transmitted from the controller unit 120 and provide the received waning message as a message function or provide the warning message jointly with various data through the harmful environment control application.

Meanwhile, the multiple communication terminals 180 may input the control command of controlling the ventilation operating device 150 (i.e., opening/closing the window or the ventilation window) by accessing the website or accessing the website through the harmful environment management application, and transmit the control command to the harmful environment management server 170.

The multiple communication terminals 180 may adopt a communication terminal selected among a smartphone, a tablet PC, a desktop computer, a notebook computer, a mapbook, and a PDA, for example.

The worker terminal 190 as a terminal which is connected the controller unit 120 through the wired/wireless communication network 160 by a low-power communication method may be directly connected to the controller unit 120 and mutually communicate with the controller unit 120 by a Bluetooth low energy (BLE) communication method, for example, and may receive and display the harmful environment control information (e.g., the harmful element measurement value, the environmental element measurement value, the control method, etc.) transmitted through the controller unit 120.

For example, the worker terminal 190 may adopt a device which easily moves, such as the smartphone, the PDA, etc., as a portable device which is usable even at a work site where harmful gas is anticipated, such as a construction site, a sewage pipe, a septic tank, etc., and which is driven by a battery.

Therefore, in an embodiment of the present invention, a harmful environment situation is determined by artificial intelligence according to a harmful element value measured by sensing at least one harmful element of carbon monoxide (CO), carbon dioxide (CO2), fine dust (PM10), ultrafine dust (PM2.5), radon, and volatile organic compound (VOC), a control method corresponding to the determined harmful environment situation is decided, and then an operation control for solving the harmful element is performed according to the decided control method to prevent casualties, and provide various home networking services including a remote control.

Further, in an embodiment of the present invention, a control method is decided by referring to data accumulated for each time zone and each place where the harmful element is measured by the artificial intelligence, and the control method is decided and controlled by supervised learning through a comparison with a reference range measurement value by using a harmful element measurement value, an environmental element measurement value, and whether there is a person provided through a plurality of IoTs, and then a dangerous situation is analyzed and predicted through unsupervised learning using accumulated data and the analyzed and predicted dangerous situation is provided to a user to actively resolve a harmful element which causes the dangerous situation, and prevent the resulting casualties.

Next, a process of sensing at least one harmful element of the carbon monoxide (CO), carbon dioxide (CO2), fine dust (PM10), ultrafine dust (PM2.5), radon, and volatile organic compound (VOC), and determining, deciding, and controlling the control method by artificial intelligence in order to resolve the harmful element by using the artificial intelligence based harmful environment control system connected to the Internet of things having the above-described configuration will be described.

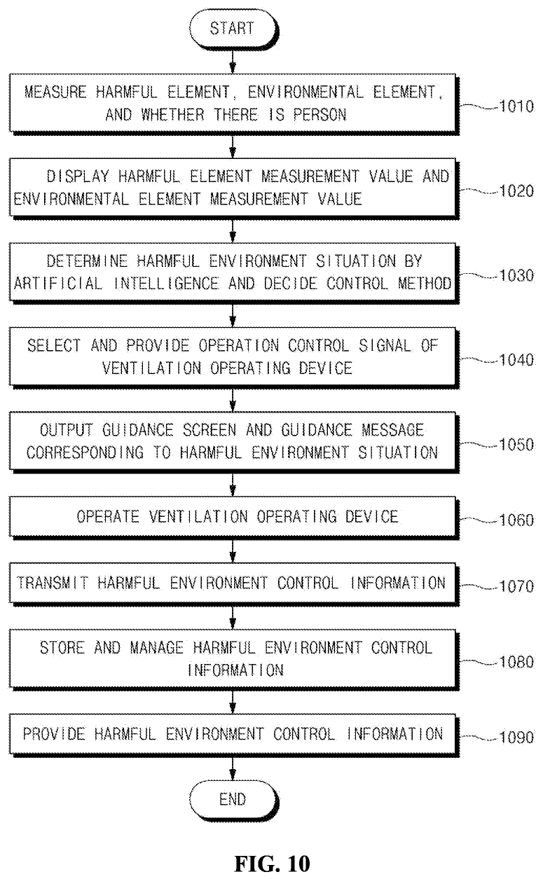

FIG. 10 is a flowchart illustrating a process of controlling an artificial intelligence based harmful environment connected to the Internet of things according to another embodiment of the present invention.

Referring to FIG. 10, a harmful element and an environmental element of a closed space, and whether there is a person of the closed space may be measured by using a plurality of Internet of things 110 (step 1010).

In the step (1010), a harmful element measurement sensor 111 may measure a harmful element including at least one of carbon monoxide (CO), carbon dioxide (CO2), fine dust (PM10), ultrafine dust (PM2.5), radon, and volatile organic compound (VOC), and an environmental element measurement sensor 112 may measure an environmental element including at least one of a temperature and a humidity, and an infrared sensor 113 may measure whether there is the person.

In addition, when a harmful element measurement value and an environmental element measurement value are provided to a controller unit 102 from a plurality of Internet of things 110, the harmful element measurement value and the environmental element measurement value may be displayed through a display panel (step 1020).

Here, the harmful element measurement values such as the carbon dioxide (CO) measurement value, the carbon dioxide (CO2) measurement value, the fine dust (PM10) measurement value, the ultrafine dust (PM2.5) measurement value, the radon measurement value, the VOC measurement value, etc., and the environmental element measurement values such as the temperature measurement value, the humidity measurement value, etc., may be cyclically displayed one by one when inputting a separate control key.

The display panel 130 is provided in a touch screen method to be provided to input the control key by touching a panel surface, of course.

Next, the controller unit 120 compares the harmful element measurement value with the reference rang measurement value to determine the harmful environment situation by the artificial intelligence according to the reference range measurement value and whether there is the person, and then decide the control method corresponding to the determined harmful environment situation (step 1030).

For example, the controller unit 120 receives the carbon monoxide (CO) measurement value from the harmful element measurement sensor 111 of the plurality of IoT sensors 110 and when the carbon monoxide (CO) measurement value is in a normal range of 50 ppm or less in the reference range measurement value, the controller unit 120 may wait for providing a subsequent measurement value while maintaining a current ventilation state, in the case of a range of 51 to 200 ppm, the harmful environment situation may determined as a primary caution state, in the case of a range of 201 to 400 ppm, the harmful environment situation may be determined as a secondary caution state, in the case of a range of 401 ppm or more, the harmful environment situation may be determined as a dangerous state, a control method may be decided, such as primarily partially opening a window or a ventilation window (e.g., 30% opening of door and window, opening of one ventilation window, etc.) may be decided according to the primary caution state, secondarily partially opening the window or the ventilation window (e.g., 60% opening of door and window, opening of two ventilation windows, etc.) may be decided according to the secondary caution state, and fully opening the window or the ventilation window (e.g., 100% opening of door and window, opening of all ventilation windows, etc.) may be decided according to the secondary caution state.

In addition, the controller unit 120 receives the carbon dioxide (CO2) measurement value from the harmful element measurement sensor 111 of the plurality of IoT sensors 110 and when the carbon dioxide (CO2) measurement value is in a normal range of 1000 ppm or less in the reference range measurement value, the controller unit 120 may wait for providing a subsequent measurement value while maintaining the current ventilation state, and a control method may be decided, such as, in the case of a range of 1001 to 2000 ppm, determining the harmful environment situation as a caution state, in the case of a range of 2000 ppm or more, determining the harmful environment situation as the dangerous state, and partially opening the window or the ventilation window in the caution state and fully opening the window or the ventilation window in the dangerous state.

In addition, the controller unit 120 receives the fine dust (PM10) measurement value and the ultrafine dust (PM2.5) from the harmful element measurement sensor 111 of the plurality of IoT sensors 110 and when the fine dust (PM10) measurement value is in a normal range of 100 μg/m 3 or less in the reference range measurement value and the ultrafine dust (PM2.5) measurement value is in a normal range of 50 μg/m 3 or less in the reference range measurement value, the controller unit 110 may wait for providing the subsequent measurement value while maintaining the current ventilation state, and a control method may be decided, such as, in a case where the fine dust (PM10) measurement value is a range of 101 to 150 lag/m³ or the ultrafine dust (PM2.5) measurement value is in a range of 51 to 75 lag/m³, determining the harmful environment situation as a caution state, in a case where the fine dust (PM10) measurement value is a range of 151 μg/m³ or the ultrafine dust (PM2.5) measurement value is in a range of 76 μg/m³, determining the harmful environment situation as the dangerous state, and partially opening the window or the ventilation window in the caution state and fully opening the window or the ventilation window in the dangerous state.

Meanwhile, the controller unit 120 receives the radon measurement value from the harmful element measurement sensor 111 of the plurality of IoT sensors 110 and when the radon measurement value is in a normal range of 148 Bq/m³ or less (or 4 pC/L or less), or less in the reference range measurement value, the controller unit 120 may wait for providing a subsequent measurement value while maintaining the current ventilation state, and a control method may be decided, such as, in the case of a range of 149 to 300 Bq/m³, determining the harmful environment situation as a caution state, in the case of a range of 301 Bq/m³ or more, determining the harmful environment situation as the dangerous state, and partially opening the window or the ventilation window in the caution state and fully opening the window or the ventilation window in the dangerous state.

In addition, the controller unit 120 receives the VOC measurement value from the harmful element measurement sensor 111 of the plurality of IoT sensors 110 and when the VOC measurement value is in a normal range of 660 ppm in the reference range measurement value, the controller unit 120 may wait for providing a subsequent measurement value while maintaining the current ventilation state, and a control method may be decided, such as, in the case of a range of 661 to 2200 ppm, determining the harmful environment situation as a caution state, in the case of a range of 2201 ppm or more, determining the harmful environment situation as the dangerous state, and partially opening the window or the ventilation window in the caution state and fully opening the window or the ventilation window in the dangerous state.

Meanwhile, in the step (1030), the controller unit 1030 may decide the control method by referring to data accumulated for each time zone and each place in which the harmful element is measured, and for each number of controls of the ventilation operating device by the artificial intelligence, and determine the harmful environment situation for each time zone and each place in which the harmful element is measured through supervised learning of machine learning including a decision tree technique, and analyze a harmful environment pattern according to the harmful element measurement value and the environmental element measurement value through unsupervised learning by referring to the accumulated data acquired by determining the harmful environment situation to determine the harmful environment situation.

Here, the controller unit 120 may combine the harmful environment control information that analyzes a supervised learning result of the machine learning each time and provides the warning message with previous accumulated data and store and manage the combined information and data as new accumulated data, and decide the control method by referring to the data accumulated for each time zone and each place, and the number of controls of the ventilation operating device 150 through the unsupervised learning.

For example, the control method may be determined by referring to data accumulated for each time zone and each place in which the harmful element is measured, and each number of controls of the ventilation operating device 150 by the artificial intelligence, and harmful element measurement values collected by sensors installed in different places (e.g., different rooms, different offices, etc.) in the closed space to accumulate and store data (i.e., a measurement state, a state, etc.) for places (e.g., bedroom, library, kitchen, veranda, living room, etc.) where and time zones (e.g., morning, day, evening, late night, etc.) when the harmful elements are frequently generated or generated relatively high.

Further, the controller unit 120 may accumulate and store the number of controls of controlling the operation of the ventilation operating device 150 according to the decided control method, and moreover, accumulate and store the number of times of transmitting the harmful environment control information including the number of risk warning times to the manager, the user, the worker, etc.

Meanwhile, the controller unit 120 may continuously determine the dangerous situation (harmful environment situation) by using the harmful element measurement value and the environmental element measurement value delivered from the plurality of IoT sensors 110 as described above, and according to respective ranges such as 51 to 200 ppm, 201 to 400 ppm, and 401 ppm or more of carbon monoxide (CO), the dangerous situation may be determined as the primary caution state, the secondary caution state, and the dangerous state, and according to respective ranges of 1001 to 2000 ppm and 2000 ppm or more of carbon dioxide (CO2), the dangerous situation may be determined as the caution state and the dangerous state.

Further, with respect to the fine dust (PM10) and the ultrafine dust (PM2.5), the controller unit 120 may determine the dangerous situation as the caution state and the dangerous state according to the respective ranges of 101-150 μg/m³ and 101-150 μg/m³ or more for the fine dust (PM10) or 51-75 μg/m³, and 76 μg/m³ or more for the ultrafine dust (PM2.5).

In addition, the controller unit 120 may determine the dangerous situation as the caution state and the dangerous state according to respective ranges of 149 to 300 Bq/m³ and 301 Bg/m³ or more for the radon and determine the dangerous situation as the caution state and the dangerous state according to respective ranges 661 to 2200 ppm and 2201 ppm or more for the VOC.

In the case of determining the dangerous situation as the dangerous state as described above, the controller unit 120 may transmit a notification message indicating that a current closed space is in the dangerous situation to the manager terminal 181 included in the plurality of communication terminals 180 through the wired/wireless communication network 160, and moreover, control to display a guidance screen for notifying the dangerous situation to the display panel 130.

Next, the controller unit 120 may select and provide the operation control signal for resolving the harmful element according to the decided control method (step 1040).

For example, when each measurement value is in the normal range, the controller unit 120 waits in a state of not generating the operation control signal and when the harmful environment situation is determined as the caution state, the controller unit 120 may generate the operation control signal for partial opening of the window or the ventilation window, such as 30% opening of the window, 60% opening of the window, opening of one ventilation window, and opening of two ventilation windows, for example, and provide the generated control signal to the ventilation operating device 150 according to the control method corresponding to the caution state.

Further, when the harmful environment situation is determined as the dangerous state, the controller unit 120 may generate the operation control signal for full opening of the window or the ventilation window, such as 100% opening of the window and full opening of the ventilation window, for example and provide the generated operation control signal to the ventilation operating device 150 according to the control method corresponding to the dangerous state.

In this case, the guidance screen corresponding to the harmful environment situation may be displayed through the display panel 130 according to the control of the controller unit 120, and the guidance message corresponding to the harmful environment situation may be voice-output through the speaker 140 (step 1050).

For example, in the case of the caution state, a guidance screen (warning message) corresponding to the caution state may be displayed through the display panel 130, and voice-output, and in the case of the dangerous state, a guidance screen (warning message corresponding to the dangerous state may be received from the controller unit 120 and displayed through the display panel 130.

For example, in the case of the caution state, voice data (warning message) corresponding to the caution state may be received from the controller unit 120, and voice-output through the speaker 140, and in the case of the dangerous state, a voice message (warning message corresponding to the dangerous state may be received from the controller unit 120 and voice-output through the speaker 140.

Here, when each measurement value is a value in the normal range or when it is measured that there is no person inside the closed space (i.e., home, office, etc.) through the infrared sensor 113, the controller unit 120 may control the guidance message voice of the speaker 140 not to be output.

Next, the ventilation operating device 150 may operate to resolve the harmful element according to the operation control signal of the controller unit 120 (step 1060).

In the step (1060), the window or the ventilation window may be opened/closed according to the operation control signal, and in the case of the caution state, the ventilation operating device 150 may operate to partially open the window or the ventilation window (e.g., 30% opening or 60% opening of the window, opening of one or two ventilation windows, etc.) according to the operation control signal provided from the controller unit 120 and in the case of the dangerous state, the ventilation operating device 150 may operate to fully open the window or the ventilation window (e.g., 100% opening of the window, fully opening of the ventilation window, etc.) according to the operation control signal provided from the controller unit 120.

Moreover, in the device such as the air-conditioner, the air cleaner, etc., the functions such as blowing, cleaning, air cleaning, etc., may also be activated according to the caution state or the dangerous state.

Next, the controller unit 120 may transmit the harmful environment control information including the harmful element measurement value, the environmental element measurement value, the harmful environment situation, and the control method to the harmful environment management server 170 through the wired/wireless communication network 160 (step 1070).

For example, the controller unit 120 may generate the harmful environment control information including the harmful element measurement value, the environmental element measurement value, the harmful environment situation, and the control method according to the normal range, the caution state, and the dangerous state, and transmit the harmful environment control information to the harmful environment management server 170 through the wired/wireless communication network 160.

The harmful environment control information may include the number of controls of the ventilation operating device 150 to be accumulated and managed, and may include the corresponding place, the corresponding time zone, etc., to be jointly accumulated and managed when the harmful environment situation is the caution state or the dangerous state.

In addition, the harmful environment management server 170 may receive, and store and manage the harmful environment control information (step 1080).

For example, the harmful environment management server 170 may store (or accumulate and store) the harmful environment control information from the controller unit 120 through the wired/wireless communication network 160, and provide the harmful environment information (harmful environment control information) for the registered closed space to the registered manager and user. The information may be provided by the method for providing the information to the plurality of communication terminals 180 through the separate harmful environment management application or the method for accessing the website of the harmful environment management server 170 by the plurality of communication terminals 180.

In addition, the harmful environment management server 170 may transmit the warning message to the manager terminal 181 and the user terminal 182 which are pre-registered when the harmful environment control information is transmitted from the controller unit 120 and transmission of the warning message is requested according to the harmful environment situation such as the caution, the danger, etc.

In addition, the harmful environment management server 170 may analyze the accumulated and stored, and managed harmful environment information based on the harmful environment control information, and separately transmit the warning message to the manager terminal 181 and the user terminal 182 when it is determined that the harmful environment situation is the dangerous situation according to the measurement value or the number of warnings.

Meanwhile, the plurality of communication terminals 180 may receive and provide the harmful environment control information transmitted by the harmful environment control server 170 through the harmful environment control application (step 1090).

For example, the plurality of communication terminals 180 may receive the harmful environment control information through the website of the harmful environment management application or the website of the harmful environment management server 170, and receive and provide the warning message according to the harmful environment situation such as caution, danger, etc.

Therefore, in an embodiment of the present invention, the control method is decided by artificial intelligence according to a harmful element value measured by sensing at least one harmful element of carbon monoxide (CO), carbon dioxide (CO2), fine dust (PM10), ultrafine dust (PM2.5), radon, and volatile organic compound (VOC), and then an operation control for solving the harmful element is performed according to the decided control method to prevent casualties, and provide various home networking services including a remote control.

Further, in another embodiment of the present invention, a control method is decided by referring to data accumulated for each time zone and each place where the harmful element is measured by the artificial intelligence, and the control method is decided and controlled by supervised learning through a comparison with a reference range measurement value by using a harmful element measurement value, an environmental element measurement value, and whether there is a person provided through a plurality of IoTs, and then a dangerous situation is analyzed and predicted through unsupervised learning using accumulated data and the analyzed and predicted dangerous situation is provided to a user to actively resolve a harmful element which causes the dangerous situation, and prevent the resulting casualties.

In the above description, various embodiments of the present invention are presented and described, but the present invention is not particularly limited thereto, and various substitutions, modifications, and changes can be made by those skilled in the art to which the present invention pertains without departing from the technical spirit of the present invention.

### DESCRIPTION OF MAIN REFERENCE NUMERALS OF DRAWINGS

110: Plurality of Internet of things sensors
120: Controller unit
130: Display panel
140: Speaker
150: Ventilation operating device
160: Wired/wireless communication network
170: Harmful environment management server
180: Plurality of communication terminals

What is claimed is:

1. An artificial intelligence based harmful environment control system connected to Internet of things, the system comprising:
a plurality of IoT sensors measuring a harmful element and an environmental element of a closed space, and whether there is a person in the closed space;
a controller unit controlling to display a harmful element measurement value and an environmental element measurement value provided from the plurality of IoT sensors, comparing the harmful element measurement value with a reference range measurement value to determine a harmful environment situation by artificial intelligence according to the reference range measurement value and whether there is the person, deciding a control method corresponding to the determined harmful environment situation, and then selecting and providing an operation control signal for resolving a harmful element according to the decided control method, selecting and controlling to output a guidance message corresponding to the harmful environment situation, and transmitting harmful element control information including the harmful element measurement value, the environmental element measurement value, the harmful environment situation, and the control method;
a display panel displaying the harmful element measurement value and the environmental element measurement value according to the control of the controller unit, and displaying the guidance screen;
a speaker voice-outputting the guidance message according to the control of the controller unit; and
a ventilation operating device operated to resolve the harmful element by receiving the operation control signal.

2. The artificial intelligence based harmful environment control system connected to Internet of things of claim 1, wherein the harmful environment control system further includes a wired/wireless communication network connected to the controller unit and transmitting the harmful environment control information;
a harmful environment management server receiving the harmful environment control information through the wired/wireless communication network, and storing and managing the harmful environment control information;
a plurality of communication terminals receiving the harmful environment control information through a harmful environment control application provided from the harmful environment management server; and
a worker terminal connected to the controller unit through the wired/wireless communication network by a low-power communication method.

3. The artificial intelligence based harmful environment control system connected to Internet of things of claim 2, wherein the plurality of communication terminals includes a manager terminal and a user terminal registered in the harmful environment control server, and the manager terminal receives a notification message corresponding to the harmful environment situation from the controller unit, and provides the received notification message.

4. The artificial intelligence based harmful environment control system connected to Internet of any one of claim 1, wherein the plurality of Internet of things sensors includes a harmful element measurement sensor may measure a harmful element including at least one of carbon monoxide (CO), carbon dioxide (CO2), fine dust (PM10), ultrafine dust (PM2.5), radon, and volatile organic compound (VOC), and an environmental element measurement sensor measuring an environmental element including at least one of a temperature and a humidity, and an infrared sensor measuring whether there is the person.

5. The artificial intelligence based harmful environment control system connected to Internet of things of claim 4, wherein the ventilation operating device opens/closes a window or a ventilation window according to the operation control signal.

6. The artificial intelligence based harmful environment control system connected to Internet of things of claim 5, wherein the controller unit decides the control method by referring to data accumulated for each time zone and each place in which the harmful element is measured, and for each number of controls of the ventilation operating device by the artificial intelligence, and determine the harmful environment situation for each time zone and each place in which the harmful element is measured through supervised learning of machine learning including a decision tree technique, and analyze a harmful environment pattern according to the harmful element measurement value and the environmental element measurement value through unsupervised learning by referring to the accumulated data acquired by determining the harmful environment situation to determine the harmful environment situation.

7. An artificial intelligence based harmful environment control method connected to Internet of things, the method comprising:
measuring a harmful element and an environmental element of a closed space, and whether there is a person in the closed space by using a plurality of IoT sensors;
comparing, by a controller unit, the harmful element measurement value with the reference rang measurement value to determine the harmful environment situation by the artificial intelligence according to the reference range measurement value and whether there is the person, and then deciding the control method corresponding to the determined harmful environment situation;
selecting and providing, by the controller unit, an operation control signal for resolving the harmful element according to the decided control method;
outputting a guidance screen and a guidance message corresponding to the harmful environment situation according to the control of the controller unit; and
operating, by a ventilation operating device, to resolve the harmful element according to the operation control signal.

8. The artificial intelligence based harmful environment control method connected to Internet of things of claim 7, wherein the harmful environment control method further includes displaying the harmful element measurement value and the environmental element measurement value through the display panel when the harmful element measurement value and the environmental element measurement value are provided to the controller unit.

9. The artificial intelligence based harmful environment control method connected to Internet of things of claim 8, wherein the harmful environment control method further includes
transmitting harmful environment control information including the harmful element measurement value, the environmental element measurement value, the harmful environment situation, and the control method; and
receiving, and storing and managing, by a harmful environment management server, the harmful environment control information.

10. The artificial intelligence based harmful environment control method connected to Internet of things of claim 9, wherein the harmful environment control method further includes
receiving and providing, by a plurality of communication terminals, the harmful environment control information transmitted by the harmful environment control server through a harmful environment control application; and
receiving, by a manager terminal included in the plurality of communication terminals, a notification message corresponding to the harmful environment situation from the controller unit, and providing the received notification message.

11. The artificial intelligence based harmful environment control method connected to Internet of any one of claim 7, wherein in the measuring and providing of whether there is the person, a harmful element measurement sensor measures a harmful element including at least one of carbon monoxide (CO), carbon dioxide (CO2), fine dust (PM10), ultrafine dust (PM2.5), radon, and volatile organic compound (VOC), an environmental element measurement sensor measures an environmental element including at least one of a temperature and a humidity, and an infrared sensor measures whether there is the person.

12. The artificial intelligence based harmful environment control method connected to Internet of things of claim 11, wherein in the deciding of the control method, the control method is decided by referring to data accumulated for each time zone and each place in which the harmful element is measured, and for each number of controls of the ventilation operating device by the artificial intelligence, and the harmful environment situation is determined for each time zone and each place in which the harmful element is measured through supervised learning of machine learning including a decision tree technique, and a harmful environment pattern according to the harmful element measurement value and the environmental element measurement value is analyzed through unsupervised learning by referring to the accumulated data acquired by determining the harmful environment situation to determine the harmful environment situation.

13. The artificial intelligence based harmful environment control method connected to Internet of things of claim 12, wherein in the operating to resolve the harmful element, a window or a ventilation window is opened/closed according to the operation control signal.

14. The artificial intelligence based harmful environment control system connected to Internet of any one of claim 2, wherein the plurality of Internet of things sensors includes a harmful element measurement sensor may measure a harmful element including at least one of carbon monoxide (CO), carbon dioxide (CO2), fine dust (PM10), ultrafine dust (PM2.5), radon, and volatile organic compound (VOC), and an environmental element measurement sensor measuring an environmental element including at least one of a temperature and a humidity, and an infrared sensor measuring whether there is the person.

15. The artificial intelligence based harmful environment control system connected to Internet of any one of claim 3, wherein the plurality of Internet of things sensors includes a harmful element measurement sensor may measure a harmful element including at least one of carbon monoxide (CO), carbon dioxide (CO2), fine dust (PM10), ultrafine dust (PM2.5), radon, and volatile organic compound (VOC), and an environmental element measurement sensor measuring an environmental element including at least one of a temperature and a humidity, and an infrared sensor measuring whether there is the person.

16. The artificial intelligence based harmful environment control method connected to Internet of any one of claim 8, wherein in the measuring and providing of whether there is the person, a harmful element measurement sensor measures a harmful element including at least one of carbon monoxide (CO), carbon dioxide (CO2), fine dust (PM10), ultrafine dust (PM2.5), radon, and volatile organic compound (VOC), an environmental element measurement sensor measures an environmental element including at least one of a temperature and a humidity, and an infrared sensor measures whether there is the person.

17. The artificial intelligence based harmful environment control method connected to Internet of any one of claim 9, wherein in the measuring and providing of whether there is the person, a harmful element measurement sensor measures a harmful element including at least one of carbon monoxide (CO), carbon dioxide (CO2), fine dust (PM10), ultrafine dust (PM2.5), radon, and volatile organic compound (VOC), an environmental element measurement sensor measures an environmental element including at least one of a temperature and a humidity, and an infrared sensor measures whether there is the person.

18. The artificial intelligence based harmful environment control method connected to Internet of any one of claim 10, wherein in the measuring and providing of whether there is the person, a harmful element measurement sensor measures a harmful element including at least one of carbon monoxide (CO), carbon dioxide (CO2), fine dust (PM10), ultrafine dust (PM2.5), radon, and volatile organic compound (VOC), an environmental element measurement sensor measures an environmental element including at least one of a temperature and a humidity, and an infrared sensor measures whether there is the person.
